(19) United States
(12) Patent Application Publication
(10) Pub. No.: US 2017/0065125 A1
(43) Pub. Date: Mar. 9, 2017

(54) BARBEQUE OVEN

(71) Applicant: Jeong-u HONG, SEOUL (KR)

(72) Inventor: Jeong-u HONG, SEOUL (KR)

(21) Appl. No.: 15/123,652

(22) PCT Filed: Mar. 4, 2015
(86) PCT No.: PCT/KR2015/002083

§ 371 Date: Sep. 5, 2016

(30) Foreign Application Priority Data
Mar. 4, 2014 (KR) 10-2014-0025477

(51) Int. Cl. A47J 37/07

(52) U.S. Cl. CPC A47J 37/0763; A47J 37/0704; A47J 37/0786

(57) ABSTRACT

A barbeque oven according to the present invention comprises: a housing having an inlet guide formed on one side thereof so as to enable hot air to be introduced therein and having a cooking space provided therein; a heat circulation guide formed integrally with the housing and formed so as to hermetically encircle the cooking space in the housing so that the heat introduced through the inlet guide may be circulated along the circumferential direction of the inside of the housing; and a grill element spaced apart from the bottom of the cooking space and supported by the inner wall of the heat circulation guide.

### TECHNICAL FIELD

The present invention relates to a barbeque oven.

### BACKGROUND ART

Barbeque is defined as dishes made outdoors by skewering various food on a skewer or putting various food on a grill and then roasting the food. Here, an example of heat sources for cooking may include charcoal, a gas burner, electricity, or the like.

Barbeque is made by a direct fire roasting scheme of roasting food directly contacting the food to heat sources and a scheme of roasting food indirectly using heat of heat sources, depending on a heating scheme. The direct fire roasting may permeate charcoal smell into fatty meat to increase a flavor of the fatty meat, but may burn or cause soot to accumulate on the meat even if a person does not pay close attention while cooking the meat which may reduce a taste of the meat and when oil drops into charcoal or a burner, may emit smoke to the outside while burning oil. Further, the soot or the burned portion stuck to a surface of meat may cause cancer, and therefore the direct fire roasting may cause a side effect of health. For this reason, an indirect fire roasting scheme is gradually extended and cooking utensils for the indirect fire roasting scheme are also restricted.

An oven that is one of the indirect heating schemes is configured to seal food and then heat the food, thereby cooking food with dry heat. The traditional barbeque oven has a form in which food put at one side of a fire pot and heat and smoke are permeated into a portion of the fire pot in which the cooking materials are put when the other side of the fire pot is fired up, to thereby cook food. As fuel is changed from firewood to gas and electricity, a heat source heating an oven and a portable cooking stove is also designed independently. As open-air meeting like camping, picnic, or the like is increased, a demand for a barbeque oven having high portability and convenience in use characteristics has been increased.

By the way, the existing barbeque oven based on the indirect heating scheme uses direct heat and therefore a volume or a size of the apparatus is excessively large, such that the barbeque oven is inconvenient to be used as a mobile type for leisure and is highly likely to cause the excessive drying or carbonization of materials due to direct fire even in the use of heat.

### DISCLOSURE

### Technical Problem

An object of the present invention is to provide a barbeque oven capable of increasing portability and usability while taking an advantage of indirect heating.

Another object of the present invention is to simplify a complicated shape in manufacturing and improving mass production while increasing heat efficiency.

### Technical Solution

According to an exemplary embodiment of the present invention, there is provided a barbeque oven, including: a housing having an inlet guide formed on one side thereof so as to enable hot air to be introduced thereinto and having a cooking space provided therein; a heat circulation guide formed integrally with the housing and formed so as to hermetically encircle the cooking space in the housing so that the hot air introduced through the inlet guide can be circulated along a circumferential direction of the inside of the housing; and a grill element spaced apart from a bottom of the cooking space and supported by an inner wall of the heat circulation guide.

The housing may include a lower first housing and an upper second housing and the heat circulation guide may include a first heat circulation guide formed in the first housing and a second heat circulation guide formed in the second housing.

The first housing and the first heat circulation guide may be integrally formed and the second housing and the second heat circulation guide may be integrally formed.

The first housing and the first heat circulation guide may be integrally formed by casting and the second housing and the second heat circulation guide may be integrally formed by the casting.

An inner wall of the heat circulation guide may be provided with a support sill part formed to support the grill element.

The housing and the heat circulation guide may be concentrically disposed.

One side of the heat circulation guide may be provided with a plurality of through holes to directly introduce the hot air.

An upper portion of the housing may be provided with a first outlet communicating with a circulation channel formed by the heat circulation guide; and a second outlet formed at a center of the first outlet and communicating with the cooking space. The barbeque oven may further include: a slide door rotatably formed on an outer side of the second outlet and selectively opening the first outlet.

The barbeque oven may further include: a fire pot part formed to support the inlet guide and providing heat to the heat circulation guide.

An inside of the housing may have a cylindrical shape and the heat circulation guide may be disposed on a circumferential surface of the housing.

An upper end of the first housing may be provided with an accommodating sill part in a circumferential direction, in which the accommodating sill part may accommodate a lower edge of the second housing.

An upper portion of the housing may be provided with a hinge-connected handle.

The barbeque oven may further include: a skewer formed to be supported by the housing in a state in which the skewer penetrates through the housing and extending in one direction to fix an object to be cooked.

The skewer may have a hollow shape and include a plurality of steam holes arranged along an extending direction of the skewer.

The barbeque oven may further include: a steam forming part disposed on an inner side of the housing; and a hose connecting between the skewer and the steam forming part.

### Advantageous Effects

According to the barbeque oven according to the exemplary embodiments of the present invention, the heat circulation guide is put in the housing to provide the sufficient heating heat to the object to be cooked within the heat circulation guide while the hot air is emitted through the first outlet via through the circulation channel between the heat circulation guide and the housing, thereby concentratedly and uniformly providing the heat to the object to be cooked while taking the advantage of the indirect heating.

Further, according to the barbeque oven according to the exemplary embodiments of the present invention, the fire pot part may be variously used independent of the heat source and may cook barbeque only by putting and heating the object to be cooked therein like in the general kettle for cooking, thereby making the portability and the convenience of use excellent.

Further, according to the example of the barbeque oven according to the exemplary embodiments of the present invention, the lower first housing and the first heat circulation guide may be integrally formed by the casting and the upper second housing and the second heat circulation guide may be integrally formed by the casting, thereby minimizing the structurally complicated shape and increasing the mass production.

### DESCRIPTION OF DRAWINGS

FIG. 1 is a perspective view of a barbeque oven 100 according to an exemplary embodiment of the present invention.

FIG. 2 is a partial cut perspective view of a portion of the barbeque oven 100 of FIG. 1.

FIG. 3 is a bottom view of the barbeque oven 100 of FIG. 1.

FIG. 4 is a perspective view of an operating state of the barbeque oven 100 of FIG. 1 for showing a use appearance of the barbeque oven 100.

FIG. 5 is a cross-sectional view of the operating state of the barbeque oven 100 of FIG. 4.

FIGS. 6A and 6B are plan views for describing an operating state of hot air outlets 130 and 140 according to an exemplary embodiment of the present invention.

FIG. 7 is a perspective view of a barbeque oven 400 according to another exemplary embodiment of the present invention.

FIG. 8 is an exploded perspective view illustrating a state in which a first housing 401 of the barbeque oven 400 of FIG. 7 is separated.

FIG. 9 is a partial cut perspective view of a portion of the barbeque oven 400 of FIG. 7.

### BEST MODE

Hereinafter, a barbeque oven according to exemplary embodiments of the present invention will be described in detail with reference to the accompanying drawings.

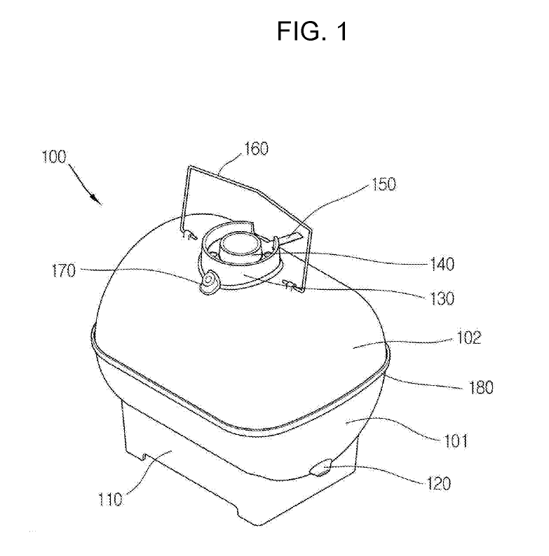

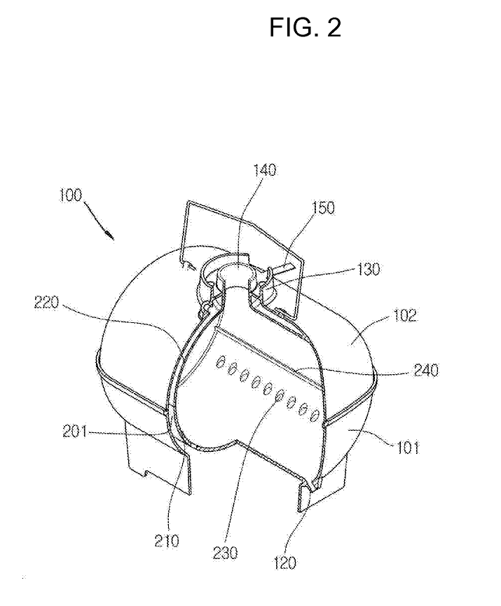

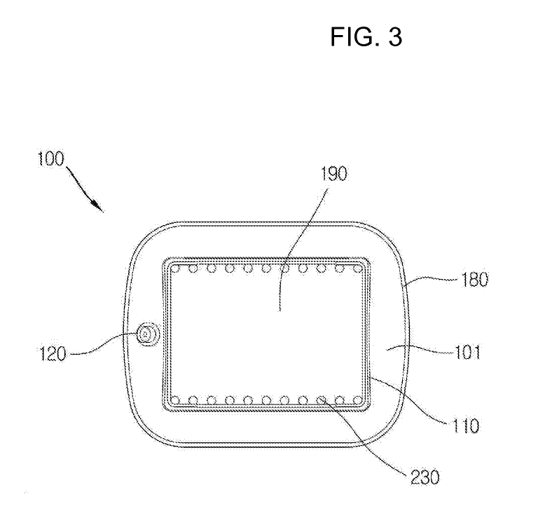

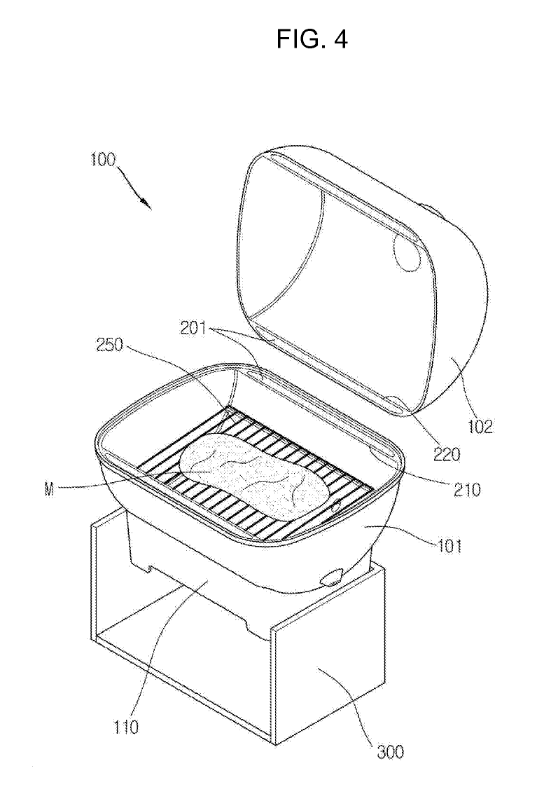

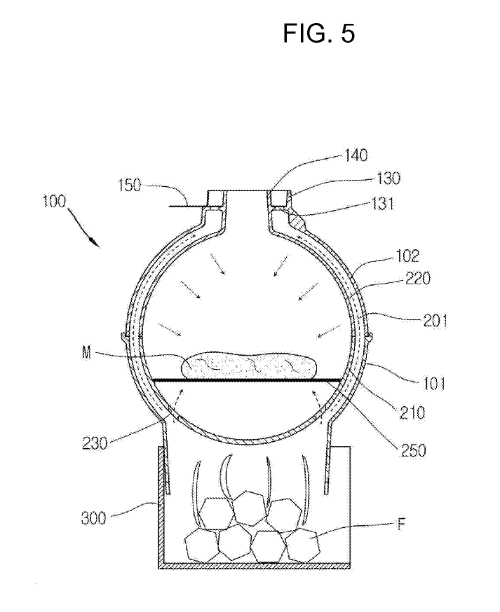

FIG. 1 is a perspective view of a barbeque oven 100 according to an exemplary embodiment of the present invention, FIG. 2 is a partial cut perspective view of a portion of the barbeque oven 100 of FIG. 1, FIG. 3 is a bottom view of the barbeque oven 100 of FIG. 1, FIG. 4 is a perspective view of an operating state of the barbeque oven 100 of FIG. 1 for showing a use appearance of the barbeque oven 100, and FIG. 5 is a cross-sectional view of the operating state of the barbeque oven 100 of FIG. 4.

Referring to FIG. 1, the barbeque oven 100 according to the exemplary embodiment of the present invention includes housings 101 and 102 having a cylindrical shape in appearance and an inlet guide 110 formed at a lower portion of the housings 101 and 102. A fire pot part 300 may be provided under the inlet guide 110 (refer to FIGS. 4 and 5). The inlet guide 110 guides heat from a heat source installed in the fire pot part 300 to be easily introduced into the housings 101 and 102. Structurally, the inlet guide 110 may supported by the fire pot part 300 and a lower end portion thereof may be provided with a cut out that may smooth the introduction of air.

One side of the lower portion of the housings 101 and 102 may be provided with an oil outlet 120 for discharging oil, water, etc. The oil outlet 120 serves to prevent the combustion of oil in the housings 101 and 102 that occurs when the oil directly drops to the heat source and keeps the inside of the housings 101 and 102 clean.

An upper portion of the housings 101 and 102 is provided with a first outlet 130 for discharging smoke and a center of the first outlet 130 is provided with a second outlet 140 extending from heat circulation guides 210 and 220. The second outlet 140 may be disposed at the first outlet 130 in a concentric form while having a diameter smaller than that of the first outlet 130.

The upper portion of the housings 101 and 102 may be provided with a hinge-connected handle 160. The handle 160 may extend from the housing 101 to prevent a user from being burned and may be assembled with the housing 101 in manufacturing.

One side of the housings 101 and 102 may be provided with a temperature check hole 170 including a thermometer inserted thereinto to measure an internal temperature of the housings 101 and 102 or a transparent window for confirming or checking a cooking state in the housings 101 and 102.

The housings 101 and 102 may have a hollow shape to have a cooking space formed therein and may generally have a lower first housing 101 and an upper second housing 102. In detail, the second housing 102 may be assembled with the first housing 101 in a form in which it may be separated from the first housing 101 or a form in which it may be opened and closed. FIG. 2 illustrates a double separable form.

An upper end portion of the first housing 101 may be provided with an accommodating sill part 180 along a circumferential direction thereof, in which the accommodating sill part 180 may accommodate a lower edge of the second housing 102. The accommodating sill part 180 serves to prevent moisture, etc., generated at an inner side or an outer side of the second housing 102 from flowing along a surface of the first housing 101, thereby increasing cleanability.

The inside of the housings 101 and 102 is provided with the heat circulation guides 210 and 220. An internal space of the heat circulation guides 210 and 220 is a cooking space in which an object to be cooked is substantially located and may be concentrically formed with respect to the housings 101 and 102 on the whole. The heat circulation guides 210 and 220 are enclosed by the housings 101 and 102 and may be integrally formed with the housings 101 and 102 and may have a partition wall shape in which it is spaced apart from an inner circumferential surface of the housings 101 and 102. The heat circulation guides 210 and 220 are provided with a circulation channel 201 by the separation from the housings 101 and 102. Like the housings 101 and 102, the heat circulation guides 210 and 220 may have a first heat circulation guide 210 that is enclosed by the first housing 101 and a second heat circulation guide 220 that is enclosed by the second housing 102.

The hot air introduced into the lower portion of the housings 101 and 102 is circulated along the circumference of the heat circulation guides 210 and 220 through the circulation channel 201 and is discharged to the outside through the first outlet 130. To selectively open the first outlet 130, an upper portion of the first outlet 130 may be provided with a slide door 150. To this end, an end portion of the first outlet 130 may be provided with a plurality of holes 131 and the slide door 150 may be formed to open the holes 131 at a specific rotation angle and seal the holes 131 at the other specific location, while being at an upper portion of the holes 131.

One side of the heat circulation guides 210 and 220 may be provided with a plurality of through holes 230. The through holes 230 may be arranged in a row or multiple rows and serve as a passage through which the hot air in the circulation channel 201 may directly be introduced into the cooking space in the heat circulation guides 210 and 220. The hot air introduced into the space in the heat circulation guides 210 and 220 may directly heat and smoke the object to be cooked.

The housings 101 and 102 and the heat circulation guides 210 and 220 have a form in which a lying cylinder is generally divided into upper and lower portions but may be manufactured at a time by casting, etc. In detail, the first housing 101 and the first heat circulation guide 210 may be integrally formed and the second housing 102 and the second heat circulation guide 220 may be integrally formed. The first housing 101 and the first heat circulation guide 210 may be integrally manufactured by the casting. To increase mass production and simplify the structure, the inlet guide 110 may be integrally manufactured with the first housing 101 and the first heat circulation guide 210 by the casting. The second housing 102 and the second heat circulation guide 220 may also be integrally manufactured by the casting. In this case, the first outlet 130 and the second outlet 140 may also be integrally manufactured with the second housing 102 and the second heat circulation guide 220 by the casting. The casting may be performed using materials such as steel, aluminum, and copper that are metal and a bottom surface 190 (refer to FIG. 3) of the first housing 101 which a flame directly contacts through the inlet guide 110 may also be coated with a film to increase heat resistance or may also have a multilayer structure.

The inside of the heat circulation guides 210 and 220 are provided with the cooking space. An inner wall of the heat circulation guides 210 and 220 may be provided with a grill element 250 and an object M to be cooked is put on the grill element 250. The inner wall of the heat circulation guides 210 and 220 may be provided with a support sill part 240 so that the grill element 250 may be put on the inner wall of the heat circulation guides 210 and 220. The grill element 250 is spaced apart from a bottom of the housing 101 at a predetermined distance, such that it may prevent the object to be cooked from being burned due to a high heating temperature delivered to the bottom of the housing 101 and may be indirectly equally supplied with the hot air circulated through the heat circulation guides 210 and 220.

The fire pot part 300 supports the housings 101 and 102 and may have a shelf shape in which charcoal, wood, or various burners may be located. To smoothly supply air, the fire pot part 300 may include a plurality of holes and as illustrated in FIG. 3, may take a form enclosing the inlet guide 110 (that is, having a size larger than that of the inlet guide) or may take a form entering the inlet guide 110 (that is, having a size smaller than that of the inlet guide). In the latter case, the fire pot part 300 is miniaturized and thus may also be formed to be carried in the housings 101 and 102 upon movement.

Both side surfaces of the fire pot part 300 may be provided with height adjusting sills to control a height with respect to the housing 101. Therefore, even if the heat source put in the fire pot part 300 is charcoal, a burner, or others, barbeque may be easily cooked by adjusting the height of the fire pot part 300.

Referring to FIG. 5, hot air from a heat source F put in the fire pot part 300 is guided by the inlet guide 110 to be introduced into the housings 101 and 102. While the hot air is circulated along the circulation channel 201 formed between the housings 101 and 102 and the heat circulation guides 201 and 220, the hot air generally heats the heat circulation guides 210 and 220 and the object M to be cooked is concentratedly heated from the heat circulation guides 210 and 220 enclosed. Therefore, the object M to be cooked may be concentratedly heated even by the indirect heating and a heat distribution of a surface of the object M to be cooked may be uniform to prevent the object M to be cooked from being sooted or burned due to a heat concentration on a specific portion of the object M.

The hot air introduced through the through hole 230 smokes the object M to be cooked. The hot air into the through hole 230 may be adjusted to be strongly or weakly introduced by the slide door 150.

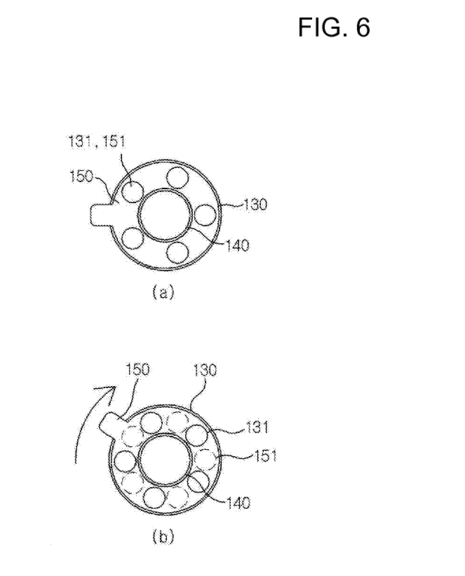

FIGS. 6A and 6B are plan views for describing an operating state of hot air outlets 130 and 140 according to an exemplary embodiment of the present invention. FIG. 6A is a diagram illustrating in which the hole 131 of the first outlet 130 matches the hole 151 of the slide door 150, in which the first outlet 130 is in an opened state. That is, in this case, the smoking by the hot air introduced into the through hole 230 and the indirect heating by the circulation channel 201 along with the direct heating are all made.

On the other hand, as illustrated in FIG. 6B, when the slide door 150 rotates, the hole 131 of the first outlet 130 mismatches the hole 151 of the slide door 150 and the first outlet 130 is in a closed state. In this case, the introduction of hot air into the through hole 230 is promoted and the smoking and the direct heating by the introduced heat may be predominantly made. To smoothly discharge smoke, the hot air outlets 130 and 140 may sufficiently extend from the housings 101 and 102 and may be provided with an assemble type stovepipe that may be separately connected additionally.

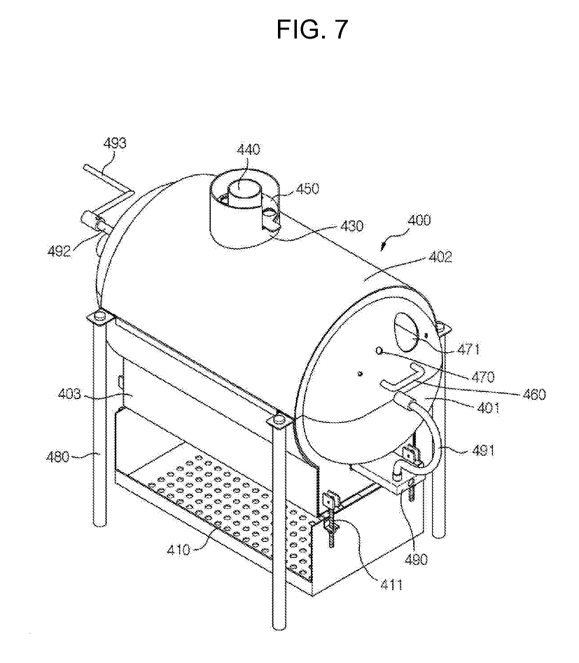

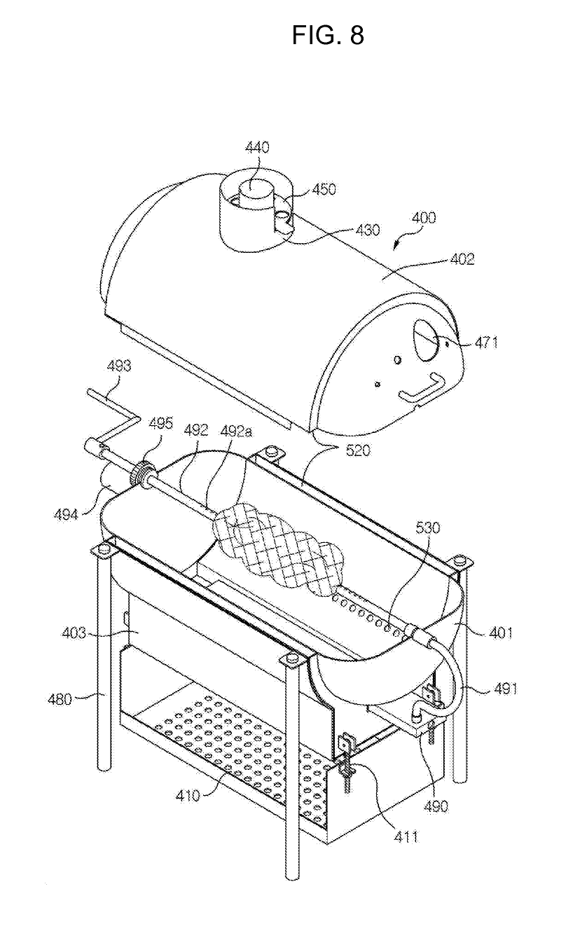

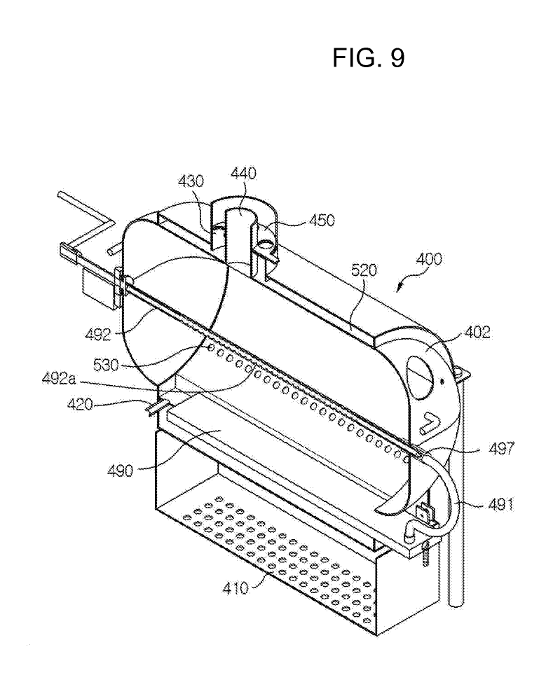

FIG. 7 is a perspective view of a barbeque oven 400 according to another exemplary embodiment of the present invention, FIG. 8 is an exploded perspective view illustrating a state in which a first housing 401 of the barbeque oven 400 of FIG. 7 is separated, and FIG. 9 is a partial cut perspective view of a portion of the barbeque oven 400 of FIG. 7.

The barbeque oven 400 according to the present example includes housings 401 and 402 having a cylindrical shape in appearance, a fire pot part 410 installed at a lower portion of housings 401 and 402, and a support 480 supporting the housings 401 and 402 and the fire pot part 410. One side of the housings 401 and 402 is provided with a skewer 492 that is supported by penetrating through the housings 401 and 402 and a handle part 493 for rotating the skewer 492.

A lower portion of the housings 401 and 402 may be provided with a shroud 403 that may help heat from a heat source put in the fire pot part 410 to be easily introduced into the housings 401 and 402. One side of the housings 401 and 402 may be provided with a transparent window 471 for confirming or checking a cooking state in the housings 401 and 402. One side of the transparent window 471 may be provided with a temperature checking hole including a thermometer inserted thereinto to measure an internal temperature of the housings 401 and 402.

The housings 401 and 402 may generally have a lower first housing 401 and an upper second housing 402. The second housing 402 may be assembled with the first housing 401 in a form in which it may be separated from the first housing 401 or a form in which it may be opened and closed. FIG. 8 illustrates a double separable form.

The inside of the housings 401 and 402 is provided with a heat circulation guide 520. An internal space of the heat circulation guide 520 is used as a space in which an object to be cooked is substantially located and may be concentrically formed with respect to the housings 401 and 402 on the whole. The heat circulation guide 520 is enclosed by the housings 401 and 402 and may have a partition wall shape in which it is spaced apart from an inner circumferential surface of the housings 401 and 402. The heat circulation guide 520 forms a circulation channel by a separation from the housings 401 and 402. Like the housings 401 and 402, the heat circulation guide 520 may also have a first guide that is enclosed by the first housing 401 and a second guide that is enclosed by the second housing 402.

An upper portion of the housings 401 and 402 is provided with a first outlet 430 for discharging heated hot air and a center of the first outlet 430 is provided with a second outlet 440 extending from heat circulation guide 520.

One side of the lower portion of the housings 401 and 402 may be provided with an oil outlet 420 for discharging oil, water, etc.

One side of the heat circulation guide 520 may be provided with a plurality of through holes 530. However, the through hole 530 may be located at an upper side of the heat circulation guide 520. In this case, a smoking effect may be more improved.

A lower portion of the housings 401 and 402 may be provided with a steam forming part 490. The steam forming part 490 has a vessel-like shape in which water is filled and is supplied with heat from the heat source of the fire pot part 410 to generate steam. One side of the steam forming part 490 is connected to a hose 491 that is connected to a skewer 492. The skewer 492 may have a hollow shape and a small steam hole 492a is arranged along an extending direction of the skewer 492. Therefore, the steam generated from the steam forming part 490 is supplied to the skewer 492 along the hose 491 and heats an object to be cooked through the steam hole 492a of the skewer 492. In the case of meat having a relatively larger volume, the steam forming part 490 and the steam hole 492a prevent a transfer of heat to an inner part of the meat from being lagged to reduce a great difference in a cooking rate between a surface and an inner part of the object to be cooked.

The fire pot part 410 may be formed in shelf form in which charcoal, wood, or various burners may be located. To smoothly supply air, the fire pot part 410 may include a plurality of holes. The fire pot part 410 may be coupled with the housings 401 and 402 by an adjusting screw 411 to adjust a distance between the fire pot part 410 and the housings 401 and 402 in response to a volume of a heat source or an intensity of a heat source.

As described above, the skewer 492 may have a bar shape so that an object to be cooked may be skewered into the skewer 492 and rotatably supported by the housings 401 and 402 so that an object to be cooked may be rotated within the housings 401 and 402. For this purpose, the skewer 492 may include a bearing. A tip of the skewer 492 may be provided with an adapter 497 to be connected to the hose 491 supplied with steam from the steam forming part 490. The adaptor 497 may serve to allow the hose 491 to keep the sealing of the skewer 492 while supporting the rotation of the skewer 492. A handle part 493 provided on one side of the skewer 492 may be used to rotate the skewer 492, but a motor part may be separately provided to automatically rotate the skewer 492.

Hot air introduced through the heat circulation guide 520 smokes an object to be cooked. The hot air into the heat circulation guide 520 may be adjusted to be strongly or weakly introduced by the slide door 450.

The steam generated from the steam forming part 490 may heat the object to be cooked having a large volume through the steam hole 492a of the skewer 492. It is possible to relieve the difference in the cooking rate between a surface and an inner part of an object to be cooked by synthetically using the heat.

The barbeque oven as described above is not limited to the configuration and the method of the exemplary embodiments described above. All or some of the above-mentioned exemplary embodiments may also be selectively combined with each other so that various modifications may be made.

1. A barbeque oven, comprising:
a housing including an inlet guide formed on one side thereof so as to enable hot air to be introduced thereinto and having a cooking space provided therein;
a heat circulation guide coupled to the housing and formed so as to hermetically encircle the cooking space in the housing so that the hot air introduced through the inlet guide is circulated along a circumferential direction of an inside of the housing; and
a grill element spaced apart from a bottom of the cooking space and supported by an inner wall of the heat circulation guide.

2. The barbeque oven of claim 1, wherein:
the housing further includes a lower first housing and an upper second housing, and
the heat circulation guide includes a first heat circulation guide formed in the first housing and a second heat circulation guide formed in the second housing.

3. The barbeque oven of claim 2, wherein:
the first housing and the first heat circulation guide are integrally formed, and
the second housing and the second heat circulation guide are integrally formed.

4. The barbeque oven of claim 3, wherein:
the first housing and the first heat circulation guide are integrally formed by casting, and
the second housing and the second heat circulation guide are integrally formed by the casting.

5. The barbeque oven of claim 1, wherein the inner wall of the heat circulation guide is provided with a support sill part formed to support the grill element.

6. The barbeque oven of claim 1, wherein the housing and the heat circulation guide are concentrically disposed.

7. The barbeque oven of claim 1, wherein one side of the heat circulation guide is provided with a plurality of through holes to directly introduce the hot air.

8. The barbeque oven of claim 1, wherein an upper portion of the housing is provided with a first outlet in communication with a circulation channel formed by the heat circulation guide and a second outlet formed at a center of the first outlet and in communication with the cooking space.

9. The barbeque oven of claim 8, further comprising:
a slide door rotatably formed on an outer side of the second outlet and selectively opening the first outlet.

10. The barbeque oven of claim 1, further comprising:
a fire pot part formed to support the inlet guide and providing heat to the heat circulation guide.

11. The barbeque oven of claim 1, wherein:
an inside of the housing has a cylindrical shape, and
the heat circulation guide is disposed on a circumferential surface of the housing.

12. The barbeque oven of claim 2, wherein an upper end of the first housing is provided with an accommodating sill part in a circumferential direction, the accommodating sill part configured to accommodate a lower edge of the second housing.

13. The barbeque oven of claim 2, wherein an upper portion of the housing is provided with a hinge-connected handle.

14. The barbeque oven of claim 1, further comprising:
a skewer formed to be supported by the housing in a state in which the skewer penetrates through the housing and extending in one direction to fix an object to be cooked.

15. The barbeque oven of claim 14, wherein the skewer has a hollow shape and includes a plurality of steam holes arranged along an extending direction of the skewer.

16. The barbeque oven of claim 15, further comprising:
a steam forming part disposed on an inner side of the housing; and
a hose connecting between the skewer and the steam forming part.
